(19) United States
(12) Patent Application Publication
(10) Pub. No.: US 2016/0147055 A1
(43) Pub. Date: May 26, 2016

(54) LED RING LIGHT AND MANUFACTURE METHOD OF LED RING LIGHT AND IMAGE MEASURING DEVICE AND OPTICAL DEVICE USING LED RING LIGHT

(71) Applicant: MITUTOYO CORPORATION, Kanagawa (JP)

(72) Inventors: Eisuke MORIUCHI, Kawasaki-shi (JP); Toshio KAWASAKI, Fuchu (JP); Yukimasa NISHIO, Kawasaki-shi (JP)

(73) Assignee: MITUTOYO CORPORATION, Kanagawa (JP)

(21) Appl. No.: 14/947,401

(22) Filed: Nov. 20, 2015

(30) Foreign Application Priority Data
Nov. 26, 2014 (JP) 2014-238386

(51) Int. Cl. G02B 21/08; F21K 99/00

(52) U.S. Cl. CPC G02B 21/084; F21K 9/30; F21K 9/90

(57) ABSTRACT

An LED ring light including a holding frame having a generally annular shape in a plan view and an aperture into which an objective lens can be inserted around a center of the holding frame; an LED substrate held inside the holding frame in a generally frusto-conical shape; and a plurality of LEDs arranged on an inner circumferential surface of the LED substrate. The LED substrate is divided at a plurality of locations in a circumferential direction of the inner circumferential surface of the holding frame by arranging a plurality of substrates side by side.

### CROSS-REFERENCE TO RELATED APPLICATIONS

The present application claims priority under 35 U.S.C. §119 of Japanese Application No. 2014-238386, filed on Nov. 26, 2014, the disclosure of which is expressly incorporated by reference herein in its entirety.

### BACKGROUND OF THE INVENTION

1. Field of the Invention

The present invention relates to an LED ring light used for image measuring devices and optical devices such as microscopes and a manufacture method of the LED ring light; and to an image measuring device and an optical device using the LED ring light.

2. Description of Related Art

For an image measuring device which captures an image of an measured object and measures the measured object based on the obtained image, and for an optical device such as an microscope observing an enlarged image of the measured object, an LED ring light is often used to illuminate the measured object.

A typical LED ring light is shown in FIGS. 1A and 1B. FIG. 1A is a perspective view of the LED ring light when viewed from a light emitting surface side; and FIG. 1B is a cross-sectional view taken in a plan parallel to an optical axis of the LED ring light shown in FIG. 1A. A typical LED ring light 1 includes a generally annular holding frame 2 in a plan view, an LED substrate 3 held inside the holding frame 2 in a generally truncated cone shape (truncated conical shape in the drawing, also referred to as a “frusto-conical shape”), and a plurality of LEDs 4 arranged on an inner circumferential surface of the LED substrate 3. In addition, the holding frame 2 provides an aperture 6 into which an objective lens 5 can be inserted around a center of the holding frame. Moreover, although not shown in FIG. 1A, reference numeral 7 in FIG. 1B is a power cable to supply power to the LED.

The LED ring light 1 as shown in FIGS. 1A and 1B holds the LED substrate 3 inside the holding frame 2 in the truncated conical shape and the plurality of LEDs 4 are arranged on the surface. According to this configuration, light emitting axes of the LEDs 4 are oriented in a direction of the measured object and therefore, illumination light of the LEDs 4 is efficiently used. In addition, a three-dimensional measured object can be illuminated effectively.

Similar to those shown in FIGS. 1A and 1B, Japanese Patent Laid-open Publication No. H10-21729 also describes an illumination device having a light emitting diode (LED) arranged on a recess side of a truncated cone inside a holding frame. In Japanese Patent Laid-open Publication No. H10-21729, in order to hold a substrate arranging the LEDs inside the holding frame in the truncated conical shape, an annular bendable printed circuit substrate 8 having a notched portion (as shown in FIG. 2) is held in a planar state. Then, the light emitting diodes 9 are arranged on the substrate 8, and a first notched side 10a and a second notched side 10b of the substrate 8 are joined or held in proximity such that the light emitting diodes 9 are arranged on the recess side of the substrate 8 formed in the truncated conical shape.

However, the method of joining or proximately holding the notch pieces by adding the notch in one single substrate as discussed in Japanese Patent Laid-open Publication No. H10-21729 leads to the following circumstance. Specifically, when even one defective LED is mixed in among the plurality of arranged LEDs, the ring light itself becomes defective. Therefore, when the entire light emitting diodes (LED) are used on one single substrate as the ring light as shown in FIG. 2, a loss is large in a case where there is a defect, and a yield rate greatly decreases.

### SUMMARY OF THE INVENTION

The present invention is provided in consideration of a circumstance above, and provides an LED ring light and a manufacture method that improves a manufacturing yield and an image measuring device and an optical device using the LED ring light.

In order to resolve the above concern, the LED ring light according to the present invention includes a generally annular holding frame in a plan view and an aperture into which an objective lens can be inserted around a center of the holding frame; a LED substrate held inside the holding frame in a generally truncated cone shape; and a plurality of LEDs arranged on an inner circumferential surface of the LED substrate. The LED substrate is divided at a plurality of locations in a circumferential direction of the inner circumferential surface of the holding frame by arranging a plurality of substrates side by side.

In addition, the plurality of substrates mentioned above can be flexible printed circuits. In this example, the flexible printed circuit substrate according to the present invention is generally called a FPC and the like. However, a flexible substrate, and specifically, a substrate having a flexibility which allows LEDs to be arranged on the substrate is sufficient.

In addition, each one of the plurality of substrates mentioned above can be generally the same shape. “Generally the same” used here means that the shapes are exactly or almost the same as a result of manufacturing based on the same standards and designs and a margin of error in manufacturing is to be allowed.

In addition, the substrates mentioned above may have one of an arc shape (also referred to as an “arcuate shape”), a trapezoid shape, and a rectangular shape.

In addition, the image measuring device and the optical device according to the present invention are an image measuring device and an optical device using any LED ring light described above. Further, the image measuring device in this example is a device measuring a measured object based on an image obtained by capturing the measured object with an optical system such as a camera; and the optical device is of a type to observe the measured object using an optical system such as a microscope, and those types are not particularly limited.

According to the present invention, the manufacture method of the LED ring light includes a holding frame having a generally annular shape in a plan view and an aperture into which an objective lens can be inserted around a center of the holding frame, the holding frame internally holding an LED substrate in a generally truncated cone shape, the LED substrate including a plurality of LEDs arranged on a surface of the substrate. The manufacturing method separates the LED substrate into a plurality of substrates at a plurality of locations in a circumferential direction of an inner circumferential surface of the holding frame, the plurality of substrates being arranged side by side and held within the holding frame.

According to the present invention, a plurality of substrates arranged the LEDs are used as the LED substrates for the LED ring light. In other words, one single substrate which has been used in the prior technology is divided into a plurality of substrates and the yield rate can be controlled for each plurality of substrates. In addition, even when a defect is found to the LED and the substrate, the number of the LEDs discarded decreases and the yield rate of the LED ring light improves as the result.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1A is a diagram illustrating an outline of an LED ring light and a perspective view from a lower side of a light emitting surface;

FIG. 1B is a diagram illustrating the outline of the LED right light and a cross-sectional view taken in a plan parallel to an optical axis;

FIG. 2 is a plan view describing an LED substrate used in a conventional LED ring light;

FIGS. 3A, 3B, and 3C are diagrams illustrating an LED substrate used in the LED ring light according to the present invention;

FIG. 4A illustrates another embodiment of the LED ring light according to the present invention, and is a perspective view from a mounted side of the LED ring light;

FIG. 4B illustrates the other embodiment of the LED ring light according to the present invention, and is a perspective view from the light emitting surface side in a state where a holding frame is opened;

FIG. 5A illustrates another embodiment of the LED ring light according to the present invention, and is a perspective view from the mounted side of the LED ring light;

FIG. 5B illustrates the other embodiment of the LED ring light according to the present invention, and is a perspective view from the mounted side in a state where the holding frame is opened;

FIG. 6A illustrates another embodiment of the LED ring light according to the present invention, and is a side view;

FIG. 6B illustrates the other embodiment of the LED ring light according to the present invention, and is a perspective view from the light emitting surface side; and

FIG. 7 illustrates an exemplary image of an image measuring device using the LED ring light according to the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

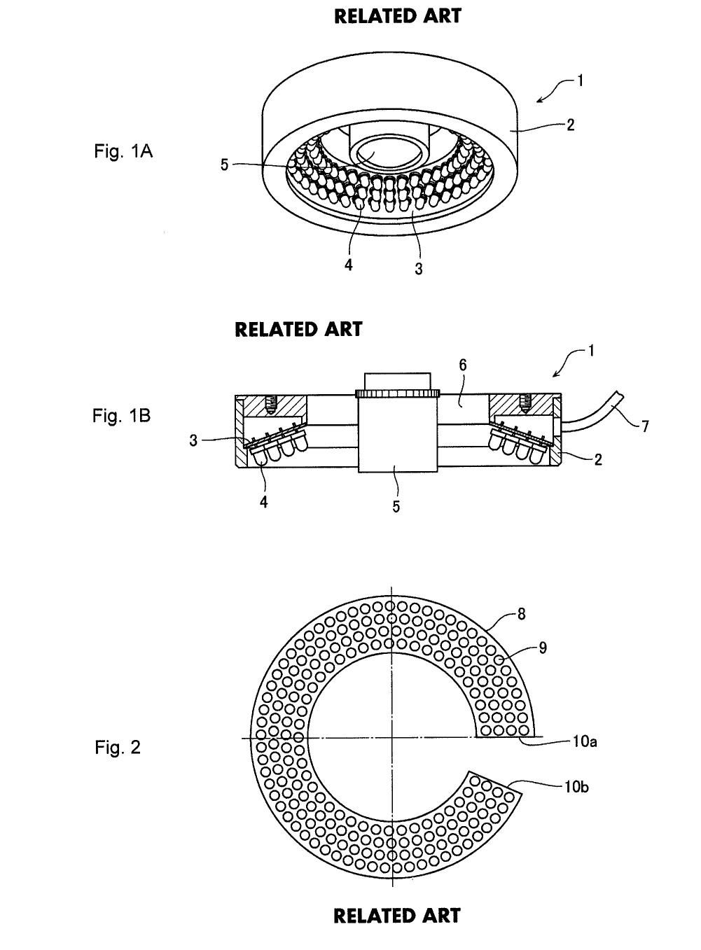

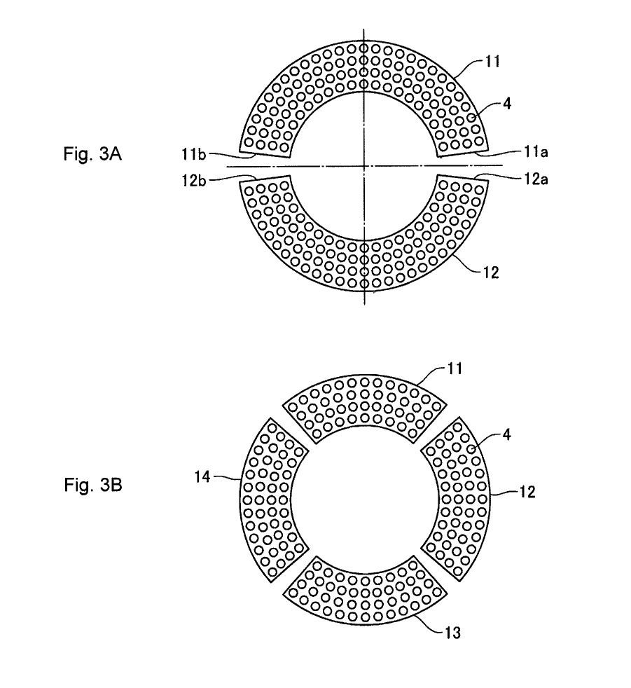

Below is a detailed explanation of favorable embodiments of the present invention with reference to the drawings. An LED ring light according to a first embodiment of the present invention is common to the LED ring light shown in FIG. 1 in an aspect where a substrate arranged with LEDs is held inside a generally annular holding frame in a truncated conical shape. In the present embodiment, however, the substrate held inside the holding frame has a differentiated feature.

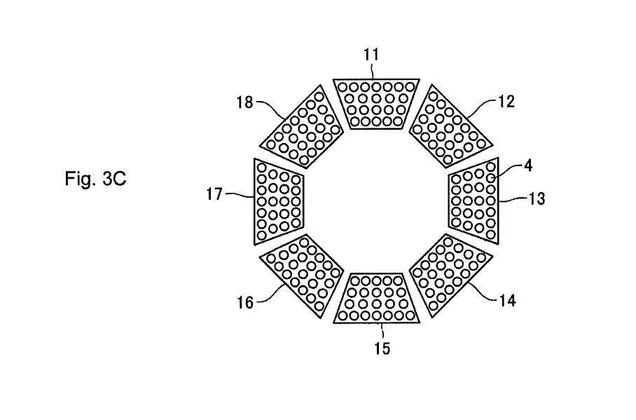

In other words, the substrate used in the LED ring light according to the present invention is formed by arranging a plural number of substrates arranged with LEDs as shown in FIGS. 3A, 3B, and 3C. Moreover, FIGS. 3A to 3C are all plan views each illustrating a state arranged in a planar shape, prior to a stage where a plurality of substrates are held inside the holding frame.

FIG. 3A shows an example using arc shape substrates 11 and 12. A plurality of LEDs 4 are arranged by soldering and the like on the substrates 11 and 12 held in a planar state. Next, a truncated cone shape (truncated conical shape in FIG. 3A) is formed by joining or holding in proximity of end portions 11a and 11b of the substrate 11 and end portions 12a and 12b of the substrate 12 respectively.

With a configuration mentioned above, the substrates 11 and 12 are arranged side by side inside the holding frame and can be held separately at two locations in a circumferential direction of an inner circumferential surface inside the holding frame (the location where the end portions 11a and 12a are joined or held in proximity and the location where the end portions 11b and 12b are joined or held in proximity).

The method for joining the end portions of the substrates 11 and 12 is not particularly limited as long as the substrates are properly held in a truncated conical shape by joining the respective end portions, and methods such as a direct bonding to join the substrates directly by heat or an indirect bonding to join the substrates via an adhesive and the like can be employed.

In addition, it is also possible not to join the end portions of the substrates and in such a case, the substrates 11 and 12 are separately held inside the holding frame in a truncated conical shape and the end portions can be held in proximity to each other. In addition, “end portions of the substrates held in proximity” used in the present specification means that the plurality of substrates are combined in a truncated cone shape, and both end portions of the substrate are brought in proximity to an extent that light intensity of the LEDs arranged on the surface does not fluctuate greatly between around the end portions and other areas.

In the above, a description was given on joining or holding the substrates in proximity, however, as a method of holding the substrates inside the holding frame, commonly known technologies can be employed such as holding by physical elements, for example, a stapler, and joining by an adhesive and the like.

In FIG. 3A, an example using two arc shaped substrates has been described, however, four arc shaped substrates (11 to 14) as shown in FIG. 3B and eight trapezoidal shaped substrates (11 to 18) as shown in FIG. 3C may be used. In addition, examples of the plurality of substrates are not limited to those shown in FIGS. 3A, 3B, and 3C, and rectangular substrates may be used as well as the number of substrates used can be selected as desired.

However, in a case where each one of the plurality substrates is in a different shape, holding the substrates inside the holding frame in a generally truncated cone shape may be difficult since each amount of deformation such as a deflection may be different. In addition, in a case where the end portions of the substrates are joined, joining locations tend to be asymmetrical in the circumferential direction inside the holding frame and resulting stress generated in the substrates becomes asymmetrical. Thus, a defect is likely to occur such as a part of the substrate peeled off. Therefore, each one of the plurality of substrates is preferably in generally a same shape in order to keep the constant stress applied to the substrates.

In addition, as a material for the plurality of substrates, a flexible printed circuit is preferably used in examples shown in FIGS. 3A to 3C. Because the flexible printed circuit is flexible, it becomes easy to form and hold the plurality of substrates inside the holding frame in a generally truncated conical shape (truncated cone shape or frusto-conical shape).

However, using a substrate with a relatively high rigidity is also possible rather than a flexible printed circuit. For example, in a case where the eight trapezoidal substrates 11 to 18 shown in FIG. 3C are formed using substrates with high rigidity, a generally truncated octagonal pyramid can be formed by joining or proximately holding end portions of each substrate. In addition, by using a plurality of rectangular shaped substrates and joining or proximately holding an upper portion (mounting surface sides of the LED ring light) of each end portion of the substrate within the holding frame, it is possible to form and hold a generally truncated pyramid shape.

As clearly described in the above embodiment, the present invention achieves the following effects, for example. The LED ring light according to the present invention, as described above, is configured by arranging the plurality of substrates side by side by dividing the substrates in the circumferential direction within the holding frame, while the conventional technology used only one substrate. Therefore, the number of LEDs mounted per each substrate decreases compared to the conventional ring light. Accordingly, even when a defect is found after the LED is mounted to the substrate, the number of the LEDs discarded decreases and the yield rate of the LED ring light improves as the result.

In addition, for the plurality of substrates arranged side by side, a shape and a number of the substrates used can be appropriately selected. Therefore, it is possible to easily adjust a light emitting axis and a light emitting amount of the LED depending on a use of the image measuring device and the optical device and a type of the measured object.

In addition, unlike the conventional ring light which required processing of a single substrate for each device applied, efficiency of products can also be improved because many types of devices can be accommodated simply by providing various substrates in different shapes and sizes.

Further, in the conventional ring light formed in a truncated cone shape by bending the single substrate, a load applied to the substrate becomes larger as the size of the LED ring light becomes bigger. On the other hand, by using a plurality of substrates as in the present invention, it is possible to easily correspond to an enlargement of the ring light since the load can be dispersed to each one of the plurality of the substrates.

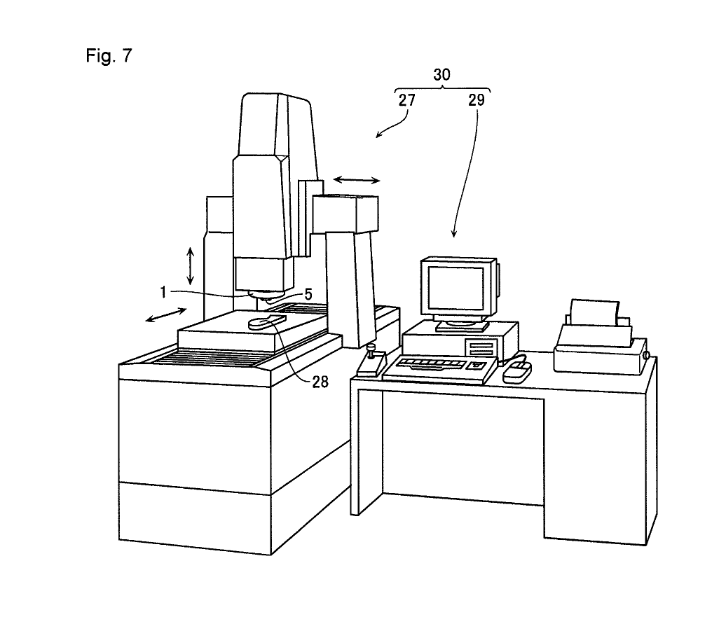

In the above, a description was given of the division of the substrate used in the LED ring light. Hereafter, a division of the holding frame holding the substrate is described as another embodiment of the present invention. FIG. 7 illustrates an exemplary image of an image measuring device using the LED ring light. As shown in FIG. 7, when the LED ring light is used for the device, the ring light is fixated to the image measuring device in a state where the objective lens of a camera provided in the image measuring device is inserted. In such a case, while the ring light is installed to the device and the like, only the objective lens may need to be replaced due to life, a change in the lens type, and the like. However, because a diameter of the ring light is often 10 cm or less, it has been difficult to remove the objective lens by inserting a hand or the like while the ring light is fixated and there has been a risk of damaging the LEDs if the lens is removed by force.

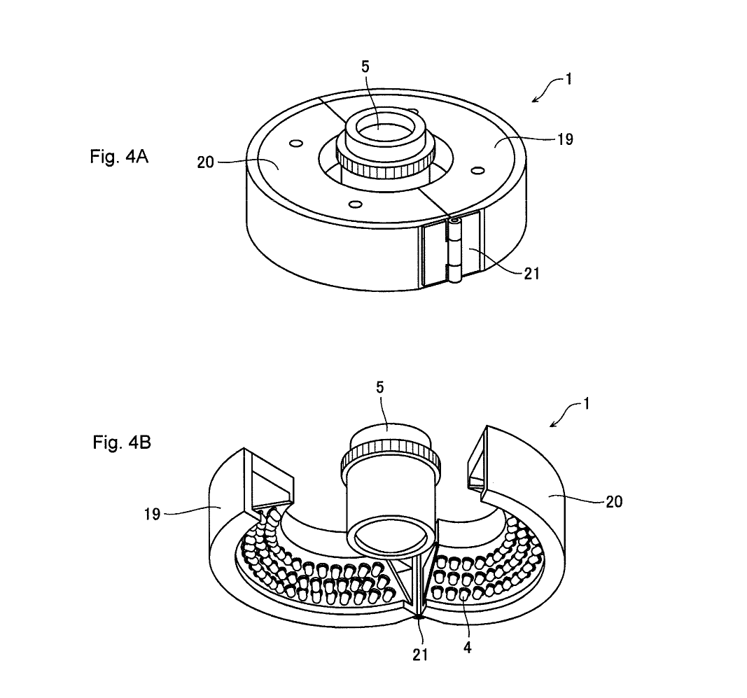

In the present invention, the LED ring light is configured to divide the substrate together with the holding frame as shown in FIGS. 4A to 6B, in order to solve the concern and further take advantage of the divided substrates described above.

The LED ring light shown in FIGS. 4A to 6B includes a plurality of holding frame pieces in the circumferential direction divided from the generally annular holding frame and the end portions of the holding frame pieces are joined or held in proximity to each other so as to be divided together with the substrate held inside the holding frame (divided into a plural number in the circumferential direction).

In FIG. 4A, the holding frame of an LED ring light 1 includes two holding frame pieces 19 and 20 divided in the circumferential direction. One side of the end portions is joined by a hinge 21 and the other side is held in proximity without joining. By this configuration, as shown in FIG. 4B, the holding frame can be divided in the circumferential direction together with the substrate.

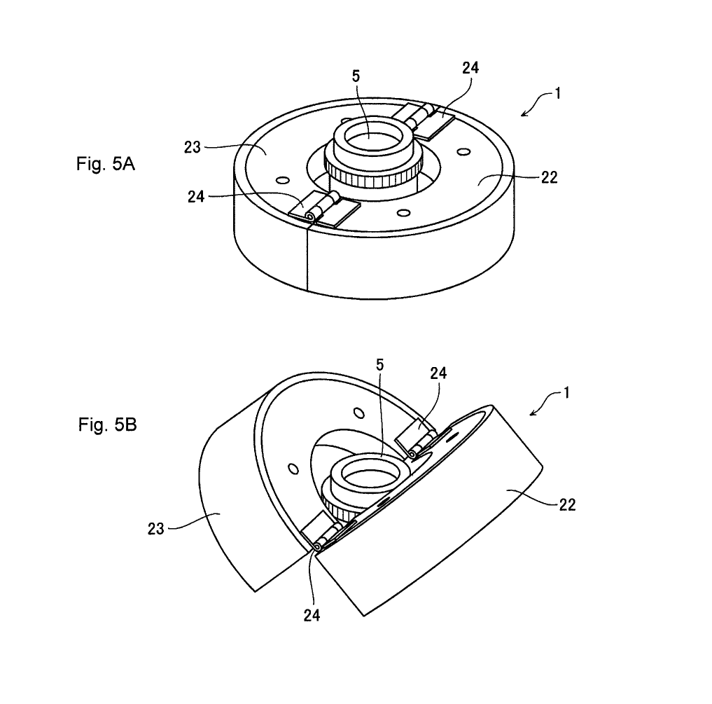

In FIG. 5A, the holding frame of the LED ring light includes two holding frame pieces 22 and 23 divided in the circumferential direction similar to the example shown in FIG. 4A. As shown in FIG. 5B, end portions of the holding frame pieces 22 and 23 are joined by hinges 24 on a side of the holding frame that is mounted to the device. With this configuration, the holding frame can be divided together with the substrate, and the division direction is an optical axis direction which is different from the FIG. 4B.

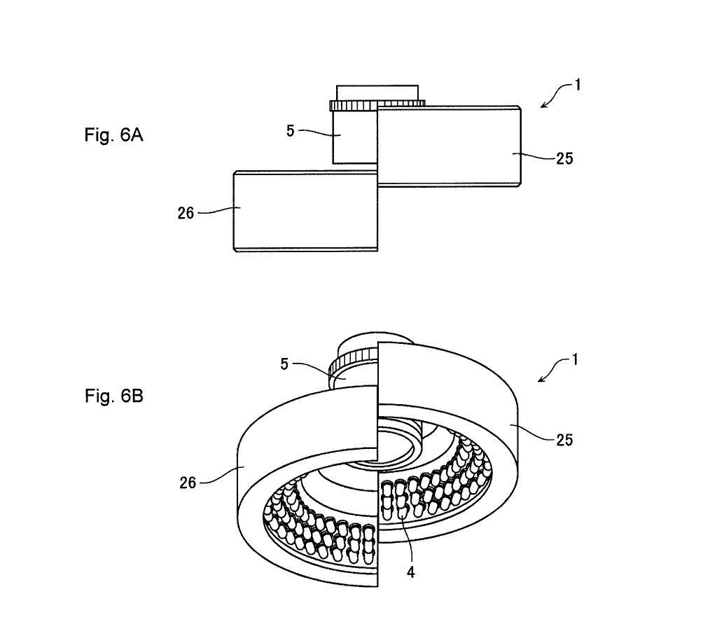

In addition, FIGS. 6A and 6B show further applied examples using the divided holding frame and two holding frame pieces 25 and 26 divided in the circumferential direction are offset in the optical axis direction. With this configuration, the LEDs 4 inside the holding frame piece 25 and the LEDs 4 inside the holding frame piece 26 have different directions for the illumination light, therefore, it is possible to capture a clearer image data that has emphasized shadows of the illuminated measured object. Moreover, while holding frame pieces 25 and 26 are configured to be offset in the optical axis direction in FIGS. 6A and 6B, it is also possible to adopt a configuration that is offset in a radial direction. In addition, for the joining method of the two holding frame pieces in FIGS. 6A and 6B, hinges can be used similarly to FIGS. 4A, 4B, 5A, and 5B.

Even though only hinges were described above in order to join the end portions of the holding frame pieces, joining the holding frame pieces to each other is not limited to the hinges and the number of the holding frame pieces dividing the holding frame is also not limited to two as described in FIGS. 4A to 6B.

By using the LED ring light described above in a measuring device main body 27 of an image measuring device 30, image data obtained by capturing an image of a measured object 28 is analyzed by a data processing apparatus 29 which is a part of the image measuring device 30. Further, while only the image measuring device has been used as an example for a device mounted with the LED ring light, LED ring light can be favorably used for optical devices such as a microscope.

The embodiments of the present invention with reference to drawings are given as noted above, however, the present invention is not limited to the embodiments described above, and may be modified as needed without departing from the scope of the present invention.

The present invention provides an LED ring light and a manufacture method capable of improving a yield rate during manufacturing, and also provides an image measuring device and an optical device using the LED ring light.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An LED ring light comprising:
a holding frame having a generally annular shape in a plan view and an aperture in a center of the holding frame into which an objective lens is insertable;
an LED substrate positioned inside the holding frame in a generally frusto-conical shape; and
a plurality of LEDs arranged on an inner circumferential surface of the LED substrate;
wherein the LED substrate is divided at a plurality of locations in a circumferential direction of the inner circumferential surface of the holding frame by a plurality of substrates in a side by side arrangement.

2. The LED ring light according to claim 1, wherein the plurality of substrates is flexible printed circuits.

3. The LED ring light according to claim 1, wherein each of the plurality of substrates has generally a same shape.

4. The LED ring light according to claim 1, wherein the plurality of substrates have one of an arcuate shape, a trapezoid shape, and a rectangular shape.

5. The LED ring light according to claim 1, wherein the holding frame includes a plurality of holding frame pieces; and
end portions of the adjacent plurality of holding frame pieces are one of joined and held in proximity to each other so as to be separable together with the LED substrate.

6. An image measuring device comprising an LED ring light, the LED ring light comprising:
a holding frame having a generally annular shape in a plan view and an aperture in a center of the holding frame into which an objective lens is insertable;
an LED substrate positioned inside the holding frame in a generally frusto-conical shape; and
a plurality of LEDs arranged on an inner circumferential surface of the LED substrate, wherein the LED substrate is divided at a plurality of locations in a circumferential direction of the inner circumferential surface of the holding frame by a plurality of substrates in a side by side arrangement

7. An optical device using an LED ring light, the LED ring light comprising:
a holding frame having a generally annular shape in a plan view and an aperture in a center of the holding frame into which an objective lens is insertable;
an LED substrate positioned inside the holding frame in a generally frusto-conical shape; and
a plurality of LEDs arranged on an inner circumferential surface of the LED substrate, wherein the LED substrate is divided at a plurality of locations in a circumferential direction of the inner circumferential surface of the holding frame by a plurality of substrates in a side by side arrangement.

8. A manufacture method of an LED ring light including a holding frame having a generally annular shape in a plan view and an aperture in the center of the holding frame into which an objective lens is insertible, the holding frame internally holding an LED substrate in a generally frusto-conical shape, the LED substrate including a plurality of LEDs arranged on a surface of the substrate, the method comprising:
separating the LED substrate into a plurality of substrates at a plurality of locations in a circumferential direction of an inner circumferential surface of the holding frame, the plurality of substrates being arranged side by side and held within the holding frame.
